(19) United States
(12) Patent Application Publication
(10) Pub. No.: US 2012/0058872 A1
(43) Pub. Date: Mar. 8, 2012

(54) MACHINE TOOL GUIDE CARRIAGE ASSEMBLY

(76) Inventor: Jürgen Röders, Soltau (DE)

(21) Appl. No.: 13/256,909

(22) PCT Filed: Mar. 9, 2010
(86) PCT No.: PCT/EP10/01468

§ 371 Date: Nov. 7, 2011

(30) Foreign Application Priority Data
Mar. 16, 2009 (DE) 10 2009 013 356.9

(51) Int. Cl. B23Q 3/157

(52) U.S. Cl. 483/13

(57) ABSTRACT

The invention relates to a machine tool guide carriage assembly, comprising a first linear guide track having at least two first parallel guide rails, wherein a first carriage is mounted on the guide track in a linearly displaceable manner, which carriage surrounds a free space in which a second carriage can be linearly displaced at a right angle to the first guide track, wherein the free space is formed by two bearing elements that are arranged at a distance from each other.

The invention refers to a machine tool guide carriage assembly including a first linear guide track or axis, along which a first carriage is linearly movable. The first carriage can be driven by means of a linear motor or in any other way. The first carriage slides on first guide rails in parallel with each other, which are formed in a manner known from the state of the art. Guide carriages move on the guide rails, with which a suitable force transmission is possible.

Further, the machine tool guide carriage assembly comprises a second linear guide track (axis, moving axis) which is arranged vertically to the first linear guide track and along which again a carriage or a component is movably supported.

In the constructions known from the state of the art, it may be disadvantageous that the guide tracks as a whole are not sufficiently stiff and/or that the bearings of the guide tracks do not show the required stiffness, such that in total a machine tool design not being very stiff results. In this context, in addition, it turns out to be disadvantageous that the controllability and the resulting adjustability for the processing of a workpiece is dependent on the stiffness and the resulting innate frequency behaviour of the machine tool and the individual components thereof. Therefore, a very precise processing might be difficult or even excluded.

It is an object underlying the invention to provide a machine tool guide carriage assembly which avoids the drawbacks of the state of the art and shows a high degree of stiffness while having a simple structure and being manufactured at low costs.

According to the invention, this object is solved by the combination of features of claim 1, the sub-claims show further advantageous embodiments of the invention.

According to the invention, it is thus provided that a carriage is mounted in a linearly displaceable manner at a first linear guide track having at least two first parallel guide rails. According to the invention, the carriage surrounds a free space in which a second carriage is linearly displaceable in a right angle to the first guide track, wherein the free space of the first carriage is formed by two mutually spaced bearing elements.

The invention stands out by a series of considerable advantages. Due to the inventive embodiment of the first carriage, there results a very high degree of stiffness, since it is formed by two mutually spaced bearing elements which are respectively guided at the parallel guide rails of the first guide track. Due to the embodiment of the guide tracks and the guide wagons used therein, the carriage is supported at the first guide track precisely and with the required stiffness. Simultaneously, the two bearing elements forming the first carriage are formed such that they also support the second carriage precisely and with high stiffness by means of parallel guide rails and associated wagons. Therewith, an overall construction is obtained, which operates very precisely and with high stiffness.

Due to the respectively provided parallelism of the guide tracks, not only the linear displaceability is possible with high precision, but also a tipping or canting is reliably excluded.

According to the invention, an optimized construction for two machine axes (linear guide tracks) it thus obtained. It is additionally possible to form one of the guide tracks in the form of a sleeve in order to support a rotatable tool spindle or workpiece spindle in a preferable manner, which is additionally displaceable in the longitudinal direction.

The inventive machine tool guide carriage assembly it thus suited for many different application purposes and can be employed for biaxial machine tools as well as for multiaxial machine tools. Its use it particularly preferable in milling machines, since a very precise processing of workpieces can be enabled in this case.

In a particularly preferred further development of the invention, it is provided that the two bearing elements respectively comprise two functional surfaces arranged in a right angle to each other, wherein one functional surface is displaceable along the first guide rail, whereas the second functional surface supports at least two second parallel guide rails of the second carriage. The two bearing elements constituting the first carriage thus form a free space having a square or rectangular cross-section, in which the second carriage is displaceably supported. Preferably, respectively two guide rails are provided in the border area of the functional surfaces at two opposite sides. This kind of bearing results in a considerable increase of the overall stiffness, since the guide rails are provided at the respective corner or edge portions of the second carriage and consequently support same precisely.

A drive for the second carriage may preferably be disposed at the third side thereof, which side is not facing the two bearing elements. The drive can be a ball bearing spindle drive or a linear motor drive. As an alternative, the drive can also be provided at one side facing one of the two bearing elements, e.g. between the guide rails; however, it is also possible to provide two drives on both sides or in any other way, with which the second carriage can be displaced.

Due to the rectangular or square cross-section of the free space, a maximum of stiffness is obtained upon a relatively small mass.

According to the invention, it is particularly preferred to form the bearing elements such that their functional surfaces are respectively formed by a disk-shaped component, wherein the disk-shaped components can be ribbed and reinforced per se and/or are additionally connected to each other by ribbed or reinforced structures.

According to the invention, the bearing elements, which respectively have a triangular cross-section in the lateral view, together with the guide rail constructions respectively provided twice and the guide wagons used therein, result in a considerable increase of the stiffness of the overall assembly.

It is obvious that also additional further guide rails can be provided according to the invention, in order to further increase the stiffness of the overall assembly.

In order to obtain a construction of the first carriage being as stiff as possible, the bearing elements are formed in a ribbed manner, as already mentioned, such that they can absorb the forces from the second carriage without deformation and transmit same to the first guide track. One possibility of a ribbing is in particular a simple cross-ribbing in the center, in addition to transverse ribs extending between the first and second guide tracks.

A further increase of the stiffness is obtained by connecting the two bearing elements additionally by means of at least one disk-shaped connection element, for closing the square or rectangular free space, in which the second carriage moves, in a box shape. Also the disk-shaped connection element is preferably ribbed. Preferably, the connection element can also serve as a mounting part for the drive unit, e.g. the linear motor. The connection between the at least one connection element and the bearing elements can be performed by screwing. Therewith, there results a closed overall system of the first carriage being inherently stable. The second carriage may rest on the first carriage through eight guide wagons on four guide rails.

According to the invention, it may further be advantageous to provide a scale, e.g. a glass scale, on at least one side of the second carriage, e.g. between the guide rails.

In the following, the invention is described on the basis an embodiment in connection with the drawing, in which:

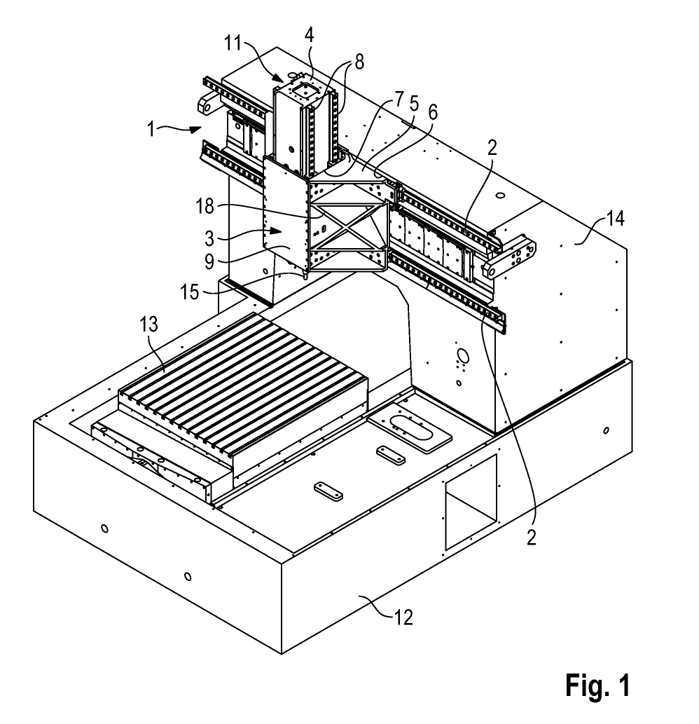

FIG. 1 shows a perspective partial view of an inventive machine tool in the form of a portal machine including the machine tool guide carriage assembly according to the invention,

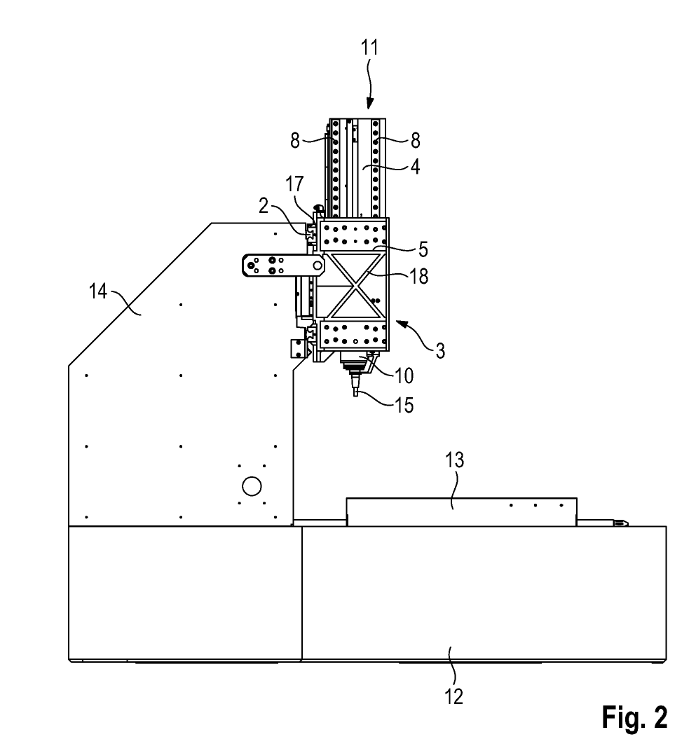

FIG. 2 shows a lateral view of the depiction of FIG. 1,

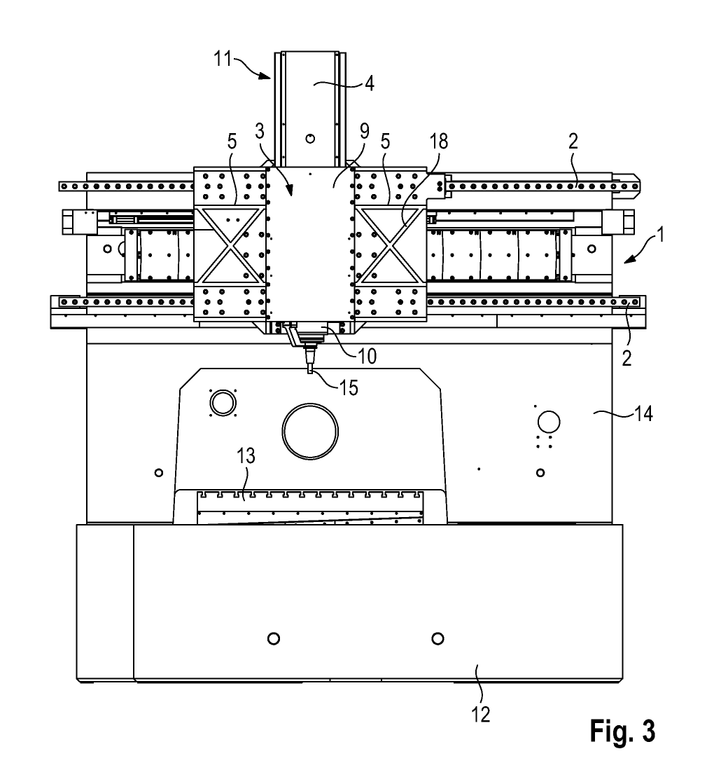

FIG. 3 shows a front view of the depiction of FIG. 1,

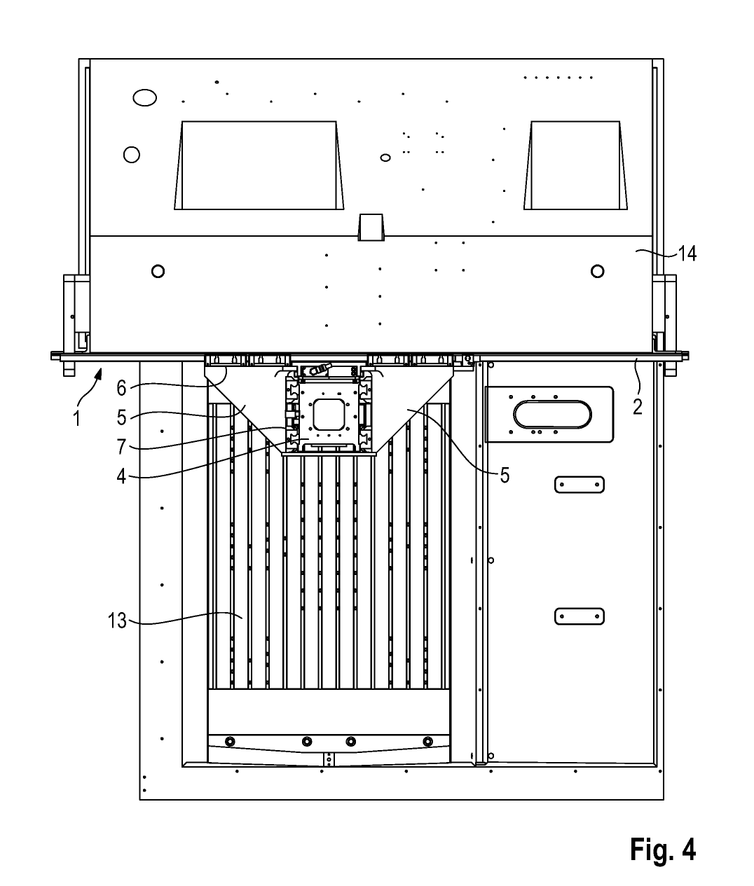

FIG. 4 shows a plan view, and

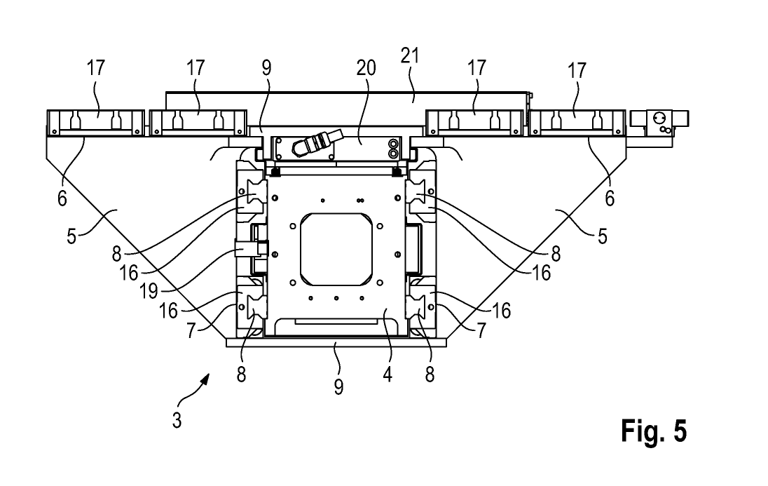

FIG. 5 shows an enlarged plan view analogous to FIG. 4.

The portal machine shown in FIG. 1 comprises a base frame 12 at which a table 13 is supported, which can optionally be displaced along the base frame 12. A portal 14 is supported at the base frame 12, such that a workpiece (not shown) clamped on the table 13 can be processed by a tool 15, wherein the tool 15 is supported in a tool spindle 10 which is supported rotatably, and optionally displaceably in a longitudinal direction as a kind of sleeve, at the second carriage 4 by means of a not shown drive,

The second carriage 4 has a substantially square or rectangular cross-section and is provided with four guide rails 8 in total, in which guide wagons 16 (see FIG. 5) move in order to form a second linear guide track 11 (axis, moving axis, Y-axis) along which the second carriage is displaceable along a vertical axis. For reasons of simplicity, the illustration of driving means and other details is omitted.

The second carriage 4 is thus supported with high stiffness and stability at its corners by means of the second guide rails 8.

The mounting of the second carriage 4 occurs at a first carriage 3 which is formed by two lateral bearing elements 5 which in turn are displaceable at two first guide rails 2 being parallel with each other. Also in this case, the drive is not shown for reasons of simplicity.

The two bearing elements 5 are mutually connected by front-side, disk-shaped connection elements 9 and thus surround the rectangular or square free space in which the second carriage 4 is vertically displaceable.

The first guide rails 2 are attached at the portal 14 and also comprise guide wagons 17, as it is known from the state of the art.

The two bearing elements 5 respectively comprise disk-shaped functional surfaces 6 and 7 which are supported at the first guide rails 2 and their associated guide wagons 17 as well as at the second guide rails 8 and their associated guide wagons 16. The disk-shaped functional surfaces 6, 7 are inherently ribbed and reinforced and mutually connected by diagonal ribbings or reinforcements, as is in particular discernible from FIG. 1. Therewith, a triangle design in the plan view is obtained (see also FIGS. 4 and 5). The two bearing elements 5 are therefore inherently very stiff and stable and constitute a very stiff overall construction due to their bearing at the parallel first guide rails 2 and second guide rails 8 being spaced from each other.

As is discernible from the figures, in particular the lateral view in FIG. 2, it is possible to arrange the rotary axis of the tool spindle 10 with a very small distance to the first guide rails 2. Therewith, short moment arms and accordingly small forces or moments result.

FIG. 5 further shows a glass scale 19 which is used for controlling the motion of the second carriage 4. Reference numeral 20 designates a linear motor which serves to generate a motion along the second linear guide track 11, whereas a linear motor 21 enables a motion along the first linear guide track 1.

The invention is not limited to the shown arrangement; rather, the machine tool guide carriage assembly can also be arranged horizontally, such that movements about different axes are enabled. It is also possible to combine two of such machine tool guide carriage assemblies within one machine tool.

### LIST OF REFERENCE NUMERALS

1 first linear guide track (axis, moving axis, horizontal axis, X-axis)
2 first guide rail
3 first carriage
4 second carriage
5 bearing element
6 functional surface
7 functional surface
8 second guide rail
9 disk-shaped connection element
10 tool spindle
11 second linear guide track (axis, moving axis, vertical axis, Y-axis)
12 base frame
13 table
14 portal
15 tool
16 guide wagon (vertical axis)
17 guide wagon (horizontal axis)
18 ribbing
19 glass scale
20 linear motor (vertical axis)
21 linear motor (horizontal axis)

1. A machine tool guide carriage assembly, comprising a first linear guide track having at least two first parallel guide rails, wherein a first carriage is mounted on the guide track in a linearly displaceable manner, wherein the first carriage surrounds a free space in which a second carriage can be linearly displaced at a right angle to the first guide track, wherein the free space is formed by two bearing elements that are arranged at a distance from each other.

2. The assembly of claim 1, wherein each bearing element comprises two functional surfaces arranged at a right angle to each other, wherein one functional surface is displaceable along the first guide rail and the second functional surface supports at least two parallel second guide rails of the second carriage.

3. The assembly of claim 2, wherein each of the functional surfaces is supported at two guide rails in parallel with each other.

4. The assembly of claim 2, wherein the functional surfaces of each bearing element are respectively formed by a disk-shaped component, wherein the disk-shaped components are strutted and/or ribbed against each other.

5. The assembly of claim 1, wherein the bearing elements are mutually connected by at least one disk-shaped connection element.

6. The assembly of claim 5, wherein two disk-shaped connection elements are provided.

7. The assembly of claim 5, wherein the at least one disk-shaped connection element is formed in a ribbed manner.

8. The assembly of claim 5, wherein the bearing elements form a substantially rectangular inner space in which the second carriage can be displaced.

9. The assembly of claim 1, wherein the second carriage supports a tool spindle in a rotatable manner.

10. The assembly of claim 1, wherein the second carriage supports a sleeve-shaped tool spindle.

11. A machine tool guide carriage assembly comprising:
a first set of at least two substantially parallel guide rails, the first set of rails define a first axis;
a carriage movably mounted to the first set of rails through at least one bearing element, the at least one bearing element being slidable along the first set of rails along the first axis;
the carriage and the at least one bearing element forming an opening, the opening defines a second axis, the second axis is substantially perpendicular to the first axis;
a linear guide track receivable in the opening, the linear guide track being slidable along the second axis; and
a tool spindle supported on an end of the linear guide track such that the tool is movable along the first axis and the second axis.

12. The assembly of claim 11, wherein the linear guide track mounts inside the opening through a second set of guide rails mounted on the at least one bearing element, and wherein the second set of guide rails are mounted to facilitate the linear guide track sliding along the second axis.

13. The assembly of claim 11, wherein the at least one bearing element includes two bearing elements, each bearing element being slidably mounted to the first set of rails along the first axis at a distance from each other.

14. The assembly of claim 13, wherein the carriage is mounted between the two bearing elements, and wherein the opening is formed by the two bearing elements and the carriage is substantially rectangular.

15. The assembly of claim 11, wherein the at least one bearing element is reinforced with at least one of strutting and ribbing.

16. The assembly of claim 11, wherein the tool spindle is sleeve shaped.

17. The assembly of claim 11, wherein the tool spindle is rotatable.

18. A machine tool guide carriage assembly comprising:
a first set of substantially parallel guide rails, the first set of rails defining a first axis;
a carriage movably mounted to the first set of rails through a first bearing element and a second bearing element, the first bearing element and the second bearing element separated by a distance along the first axis, each of the first bearing element and the second bearing element having a first surface along the first axis, each of the first surfaces mounting to the first set of guide rails such that each carriage is slidable along the first set of rails along the first axis;
the carriage, the first bearing element, and the second bearing element forming a substantially rectangular opening, the opening defining a second axis, the second axis being substantially perpendicular to the first axis;
the first bearing element and the second bearing element each having a second surface along the second axis, each second surface comprising two function surfaces;
a linear guide track receivable in the opening, the linear guide track having a second set of substantially parallel rails, the second set of rails supported by the first bearing element second surface and the second bearing element second surface such that the linear guide track is slidable along the second axis; and
a rotatable sleeve shaped tool spindle supported on an end of the linear guide track such that the tool is movable along the first axis and the second axis.
